(19) United States
(12) Patent Application Publication
(10) Pub. No.: US 2026/0155845 A1
(43) Pub. Date: Jun. 4, 2026

(54) FR1/FR3 TRANSCEIVER ARCHITECTURE SUPPORTING FR2 ANTENNA MODULE WITH MINIMAL ADDITIONAL HARDWARE

(71) Applicant: MEDIA TEK INC., Hsinchu (TW)

(72) Inventors: Sang-June Park, San Jose, CA (US); Hsin-Hung Chen, Hsinchu (TW); Hsiang-Hui Chang, Hsinchu (TW); David Ritter, San Jose, CA (US)

(21) Appl. No.: 19/344,887

(22) Filed: Sep. 30, 2025

Related U.S. Application Data
(60) Provisional application No. 63/726,675, filed on Dec. 2, 2024.

(51) Int. Cl. H04B 1/00

(52) U.S. Cl. CPC H04B 1/006; H04B 1/0075

(57) ABSTRACT

A wireless device operates in a first mode by configuring a cross-switch to establish a first signal path from a Frequency Range 3 (FR3) antenna element to a transceiver through a shared interconnect. The wireless device operates in a second mode by configuring the cross-switch to establish a second signal path from a Frequency Range 2 (FR2) module to the transceiver through the shared interconnect. The FR2 module outputs FR2 intermediate frequency (IF) signals. The wireless device transmits and receives signals through the shared interconnect in a non-concurrent manner between the first mode and the second mode.

### CROSS-REFERENCE TO RELATED APPLICATION(S)

This application claims the benefit of U.S. Provisional Application Ser. No. 63/726,675, entitled “FR1/FR3 TRANSCEIVER ARCHITECTURE SUPPORTING FR2 ANTENNA MODULE WITH MINIMAL ADDITIONAL HARDWARE” and filed on Dec. 2, 2024, which is expressly incorporated by reference herein in its entirety.

### BACKGROUND

### Field

The present disclosure relates generally to wireless communications, and more particularly, to techniques of a shared routing architecture for radio frequency (RF) and intermediate frequency (IF) signals of different frequency bands in a multi-band wireless communication device.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device supporting multiple frequency ranges. The wireless device operates in a first mode by configuring a cross-switch to establish a first signal path from a Frequency Range 3 (FR3) antenna element to a transceiver through a shared interconnect. The wireless device operates in a second mode by configuring the cross-switch to establish a second signal path from a Frequency Range 2 (FR2) module to the transceiver through the shared interconnect. The FR2 module outputs FR2 intermediate frequency (IF) signals. The wireless device transmits and receives signals through the shared interconnect in a non-concurrent manner between the first mode and the second mode.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram illustrating a shared routing architecture that enables a common interconnect to be used for both Frequency Range 3 (FR3) radio frequency (RF) signals and Frequency Range 2 (FR2) intermediate frequency (IF) signals.

FIG. 6 is a flow chart of a method for operating a wireless device supporting multiple frequency ranges.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

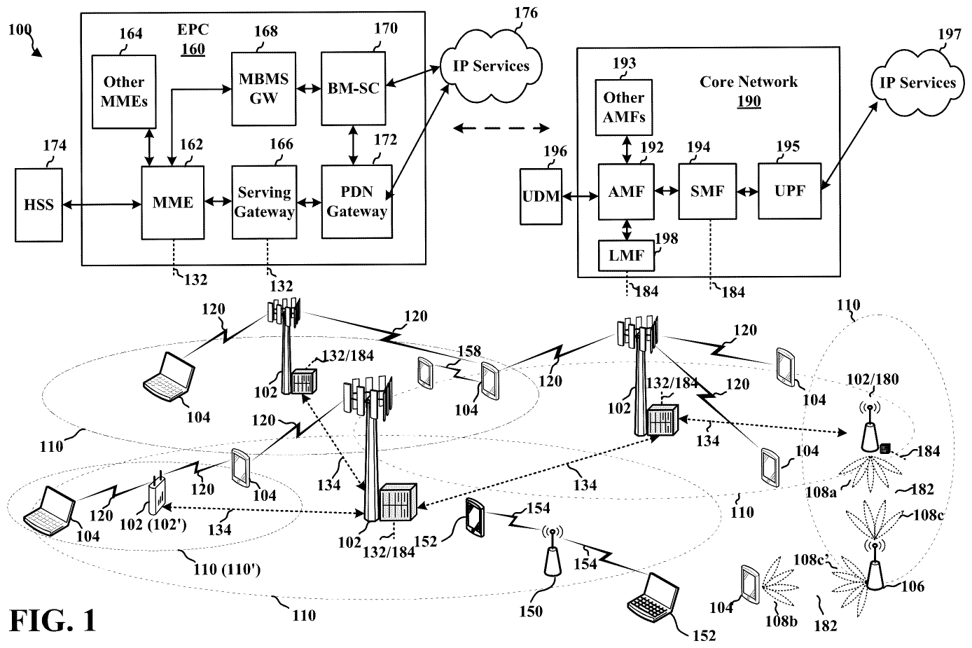

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

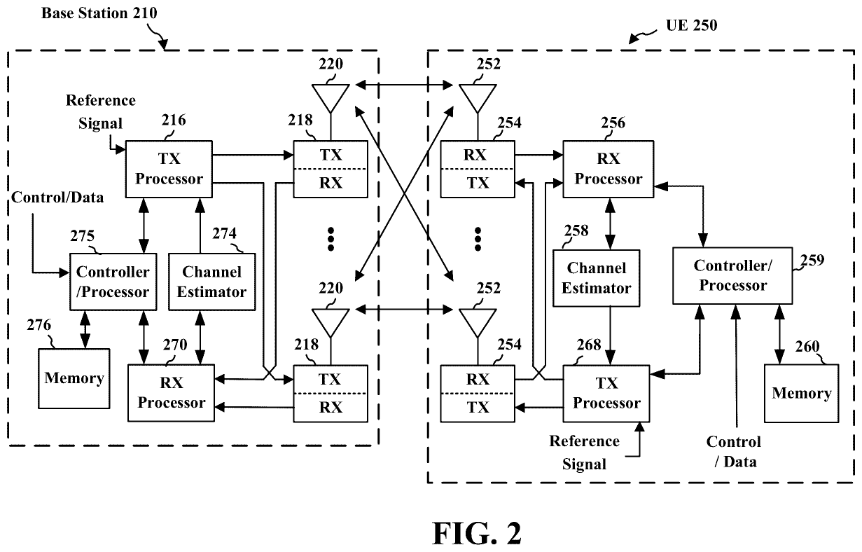

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

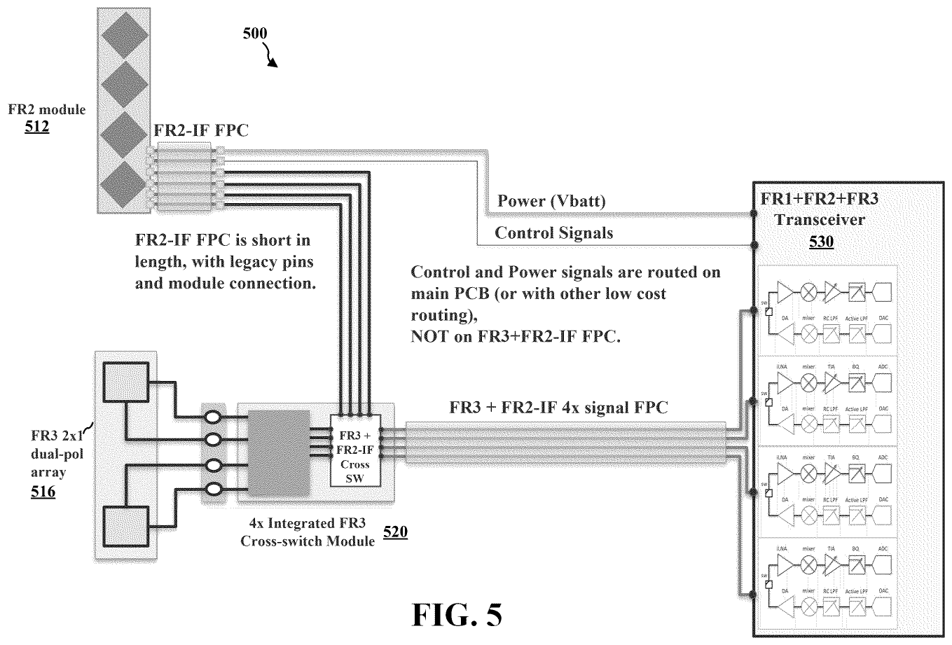

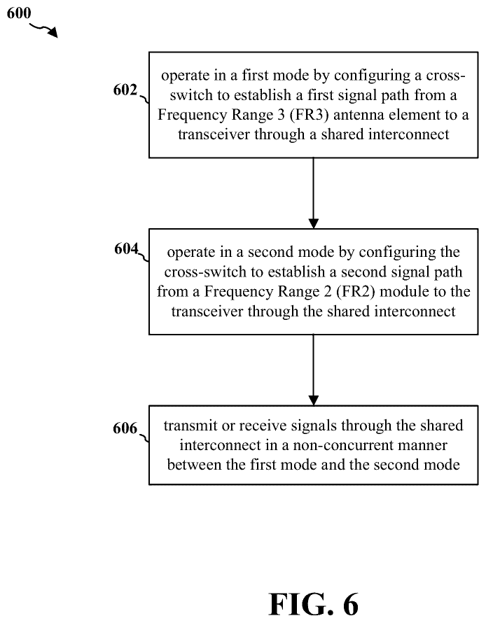

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

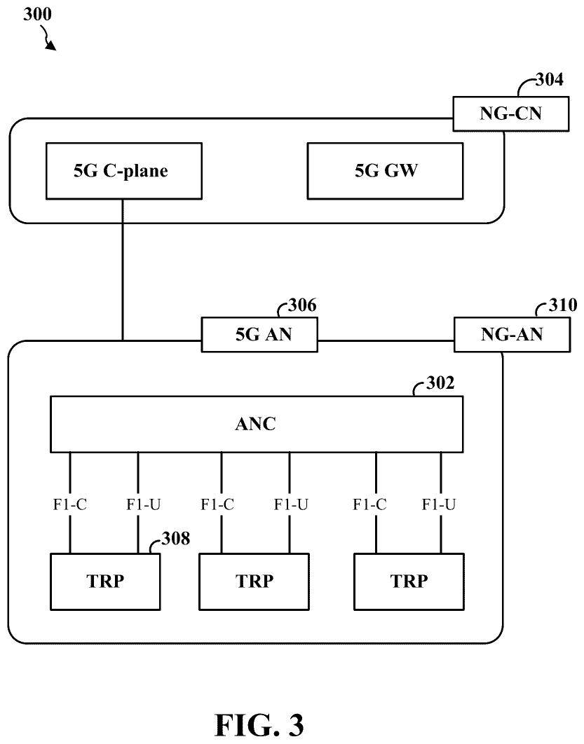

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

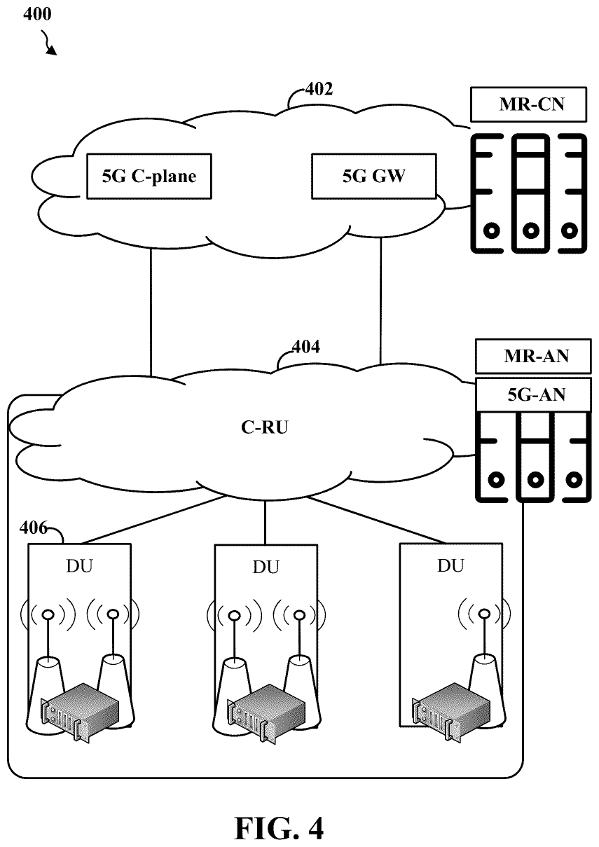

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 illustrating a shared routing architecture that enables a common interconnect to be used for both Frequency Range 3 (FR3) radio frequency (RF) signals and Frequency Range 2 (FR2) intermediate frequency (IF) signals. This architecture may be utilized by a UE (e.g., the UE 104) and demonstrates how a single transceiver can efficiently support multiple frequency ranges (FR1, FR2, and FR3) through hardware sharing and non-concurrent operation.

FR2, or Frequency Range 2, refers to the millimeter wave (mmWave) bands utilized in 5G cellular communications. The frequency range for FR2 is specified as being greater than 24 GHz, and more specifically as 24-71 GHz. FR2 architecture may use a heterodyne configuration. In this setup, the high-frequency mmWave signal is not processed directly by the main transceiver but is first down-converted to a more manageable Intermediate Frequency (IF) within the FR2 antenna module before being sent to the transceiver for further processing.

FR3, or Frequency Range 3, is a new set of frequency bands associated with emerging 6G cellular technology. The disclosures consistently identify the frequency range for FR3 as 7-15 GHz. Unlike the described FR2 architecture, FR3 signals can be handled as direct Radio Frequency (RF) signals. These signals are routed from an FR3 antenna array to the transceiver for processing without the intermediate frequency conversion step that characterizes the FR2 implementation.

A FR2 module 512 operates in the millimeter wave frequency range and employs a heterodyne configuration that requires two frequency conversions. The first conversion produces an intermediate frequency (IF) signal, which is then converted to the high frequency millimeter wave signal. Adjacent to the FR2 module 512 is a FR3 2×1 dual-polarization array 516, which supports the new 6G frequency bands in the 7-15 GHz range.

At the center of the architecture is a 4× integrated FR3 cross-switch module 520, which serves as the switching element that enables the shared routing functionality. The cross-switch module 520 can route signals from either an FR3 antenna, such as the FR3 2×1 dual-pol array 516 or the FR2 module 512, to a common signal path. When operating in FR3 mode, the cross-switch 520 connects the FR3 antenna 516 directly to the shared interconnect. When operating in FR2 mode, the cross-switch 520 routes the FR2-IF signal from the FR2 module 512 to the same shared interconnect.

A transceiver 530 represents a unified transceiver integrated circuit that can process signals from all three frequency ranges (i.e., FR1, FR2, FR3), or only FR2 and FR3. The transceiver 530 includes multiple signal processing chains that can be configured to handle either FR3 RF signals or FR2-IF signals, depending on the operational mode. The internal architecture of the transceiver 530 shows the digital front end (DFE) and analog chains that are reused for both FR3 and FR2 operations, reducing the overall die area and pin count requirements.

The FR2 module 512 connects to the cross-switch module 520 through a short FR2-IF FPC (flexible printed circuit). This FR2-IF FPC is intentionally kept short in length and uses legacy pins and module connections to minimize cost. The main signal routing from the cross-switch module 520 to the transceiver 530 is accomplished through a FR3+FR2-IF 4× signal FPC (although other configurations, such as 2× or 8×, are also contemplated), which carries only the high-frequency data signals.

The architecture implements a cost-effective signal routing strategy by separating the power and control signals from the high-frequency data path. The power supply (Vbatt) and control signals for the FR2 module 512 are routed on the main printed circuit board (PCB) or through other low-cost routing methods, rather than being integrated into the expensive FR3+FR2-IF FPC. This separation significantly reduces the complexity and cost of the high-frequency flexible interconnect, as it only needs to handle the 4× data signals without the additional burden of power and control signal routing.

The non-concurrent operation principle underlying this architecture assumes that the device will not need to simultaneously transmit or receive on both FR2 and FR3 bands. This assumption enables the sharing of transceiver signal paths, interconnects, and processing resources between these two frequency ranges, resulting in substantial hardware and cost savings compared to conventional architectures that require dedicated resources for each frequency range.

The evolution of wireless communication systems toward 6G networks introduces significant technical and economic challenges in supporting multiple frequency ranges within a single device architecture. The conventional approach to supporting FR2 millimeter wave bands alongside emerging FR3 bands requires substantial hardware duplication, which directly impacts both system complexity and manufacturing costs.

When implementing support for FR2 bands in conjunction with FR3 bands, traditional architectures necessitate additional transceiver signal paths to enable simultaneous operation across both frequency ranges. This requirement stems from the fundamental differences in frequency characteristics and signal processing requirements between FR2 millimeter wave signals and FR3 signals in the 7-15 GHz range. Each frequency range typically demands its own dedicated signal chain within the transceiver 530, including separate analog front-end circuits, mixers, filters, and digital processing blocks. This duplication of hardware resources significantly increases the die area of the transceiver integrated circuit and raises the overall bill of materials for device manufacturers.

The cost implications extend beyond the transceiver itself to the interconnect infrastructure. Supporting FR2 bands conventionally requires extra transceiver ports specifically allocated for FR2 signals, as well as dedicated interconnect interfaces that can handle the unique requirements of millimeter wave signal transmission. These dedicated interfaces cannot be shared with other frequency ranges due to differences in signal characteristics, impedance matching requirements, and electromagnetic interference considerations. The FR2 module 512 shown in FIG. 5 traditionally would require its own set of transceiver pins and a completely separate signal path to the transceiver 530, independent of the FR3 signal path from the FR3 dual-pol array 516.

Perhaps the most significant cost driver in conventional FR2 implementations is the requirement for expensive flexible cables and connectors. The FPC used for FR2 interconnects must meet stringent performance specifications to maintain signal integrity at millimeter wave frequencies. These specifications include precise impedance control, minimal insertion loss, excellent shielding characteristics, and stable performance across temperature variations. Manufacturing such high-performance FPCs requires specialized materials, advanced fabrication processes, and rigorous quality control, all of which contribute to substantially higher costs compared to standard interconnect solutions.

The FR2 transceiver architecture itself presents additional complexity due to its heterodyne configuration. The FR2 module 512 implements a two-stage frequency conversion process, first down-converting the received millimeter wave signal to an intermediate frequency (IF), and then processing this IF signal for baseband conversion. This heterodyne approach, while necessary for practical millimeter wave implementations, adds another layer of hardware requirements and signal routing complexity. The IF signals generated by the FR2 module 512 must be routed to the transceiver 530 through high-quality interconnects, traditionally requiring a dedicated FR2-IF FPC that can maintain signal integrity while supporting the required bandwidth.

The interconnect interface challenges are further compounded by the physical constraints of mobile device design. The FR2 module 512 is often positioned at a considerable distance from the main transceiver 530 due to antenna placement requirements and thermal management considerations. This spatial separation necessitates longer flexible interconnects (and/or through high loss PCB), which not only increases signal loss but also raises the cost of the high-performance FPC materials required. Additionally, these long interconnects must carry not only the high-frequency data signals but also power supply voltages and control signals for the FR2 module 512, further increasing the complexity and cost of the FPC design.

These technical and economic challenges have historically limited the widespread adoption of FR2 millimeter wave technology in consumer devices. The combination of additional transceiver signal paths, extra ports and interfaces, and expensive interconnect solutions creates a significant barrier to cost-effective implementation. Device manufacturers must balance the desire to support advanced millimeter wave capabilities with the economic realities of consumer product pricing, often resulting in FR2 support being limited to premium device models. The architecture shown in FIG. 5, with its integrated FR3 cross-switch module 520 and shared signal routing approach, represents an innovative solution to these longstanding challenges by enabling hardware resource sharing between FR2 and FR3 bands while maintaining performance requirements.

The architecture shown in FIG. 5 implements a design principle of non-concurrent operation between FR2 and FR3 bands, which enables significant hardware resource sharing and cost reduction. This non-concurrent operation means that the transceiver 530 processes either FR3 signals or FR2 signals at any given time, but not both simultaneously. The mutual exclusivity of FR2 and FR3 operation allows the same physical signal paths within the transceiver 530 to be time-multiplexed between these two frequency ranges, eliminating the need for dedicated, parallel signal processing chains that would otherwise be required for concurrent operation.

The sharing of FR3 transceiver signal paths with FR2 represents a significant departure from conventional multi-band transceiver architectures. In the transceiver 530, the analog and digital signal processing chains that would typically be dedicated exclusively to FR3 operation are designed to also accommodate FR2 intermediate frequency (IF) signals. This dual-purpose capability is possible because the FR2-IF signals, after down-conversion in the FR2 module 512, have frequency characteristics that fall within a range compatible with the FR3 signal processing infrastructure (i.e., in the 7-15 GHz range). The transceiver 530 can dynamically reconfigure its internal signal paths to process either the FR3 RF signals from the FR3 dual-pol array 516 or the FR2-IF signals from the FR2 module 512, depending on the current operational mode.

The integrated FR3 cross-switch module 520 serves as the central routing element that enables this signal path sharing. Positioned between the antenna elements and the transceiver 530, the cross-switch module 520 contains switching circuitry that can direct signals along different paths based on the operational mode. When the system operates in FR3 mode, the cross-switch module 520 establishes a direct connection between the FR3 dual-pol array 516 and the FR3+FR2-IF 4× signal FPC, allowing FR3 RF signals to flow to the transceiver 530. Conversely, when the system switches to FR2 mode, the cross-switch module 520 reconfigures its internal connections to route the FR2-IF signals from the FR2 module 512 onto the same FR3+FR2-IF 4× signal FPC. As such, only one signal type occupies the shared interconnect at any given time, maintaining signal integrity while maximizing hardware utilization.

The FR2-IF interconnect sharing with the FR3 RF interconnect represents another feature in this architecture. Traditional implementations would require separate, dedicated interconnects for FR2-IF and FR3 RF signals due to their different frequency ranges and signal characteristics. However, the architecture in FIG. 5 demonstrates that a single FR3+FR2-IF 4× signal FPC can effectively carry both signal types when they are not transmitted concurrently. This shared interconnect approach is feasible because the FR2-IF signals, having been down-converted from millimeter wave frequencies to intermediate frequencies, possess electrical characteristics that are compatible with the transmission line properties optimized for FR3 RF signals. The FR3+FR2-IF 4× signal FPC maintains appropriate impedance matching and signal integrity for both signal types, eliminating the need for two separate high-performance flexible interconnects.

The addition of the FR3 RF to FR2-IF cross-switch functionality within the integrated FR3 cross-switch module 520 provides the necessary signal routing flexibility to support this shared architecture. The cross-switch module 520 implements high-frequency switching elements that can handle the signal routing requirements for both FR3 RF signals in the 7-15 GHz range and FR2-IF signals at intermediate frequencies. The switching elements within the module 520 maintain low insertion loss and high isolation between switched paths. Signal quality is preserved regardless of the selected routing configuration. The cross-switch module 520 responds to control signals from the transceiver 530 or a system controller to dynamically change the signal route from FR3 RF to FR2-IF based on the communication requirements of the device.

The architecture takes advantage of the inherently lower cost of FR3 RF interconnect technology compared to traditional FR2 millimeter wave interconnects. The FR3+FR2-IF 4× signal FPC, while still requiring controlled impedance and good signal integrity, does not need to meet the extremely stringent requirements of direct millimeter wave signal transmission. This relaxation of specifications allows for the use of more cost-effective materials and manufacturing processes while still maintaining adequate performance for both FR3 RF and FR2-IF signal transmission. Additionally, the architecture minimizes the FR2-IF interconnect length by utilizing a short (low loss) FR2-IF FPC between the FR2 module 512 and the cross-switch module 520. This short interconnect can use legacy pins and module connections, further reducing implementation costs while maintaining compatibility with existing FR2 module designs.

The separation of power and control signal routing from the high-frequency data path provides additional cost optimization. As indicated in FIG. 5, the power supply (Vbatt) and control signals for the FR2 module 512 are routed on the main PCB or through other low-cost routing methods, rather than being integrated into the FR3+FR2-IF 4× signal FPC. This separation allows the expensive high-frequency flexible interconnect to be optimized solely for data signal transmission, reducing its complexity and cost. The main PCB routing for power and control signals can utilize standard PCB manufacturing techniques and materials, which are significantly less expensive than the specialized materials required for high-frequency flexible interconnects.

As described supra, the FR3 and FR2-IF shared routing architecture implements a comprehensive hardware sharing strategy that extends beyond the signal path multiplexing to encompass the entire interconnect infrastructure between the transceiver 530 and the antenna elements. This architecture redefines how multi-band transceivers interface with different frequency range modules by utilizing common physical resources for both FR3 and FR2-IF signal transmission.

In the transceiver 530 shown in FIG. 5, the same physical pins that interface with FR3 RF signals also accommodate FR2-IF signals through time-division multiplexing. This pin sharing eliminates the need for separate dedicated pin allocations for each frequency range, reducing the overall pin count of the transceiver package. The transceiver 530 implements internal multiplexing circuitry that dynamically configures the pin functionality based on the operational mode, allowing the same physical connections to serve dual purposes without compromising signal integrity or requiring additional package complexity.

The RF routing infrastructure on the printed circuit board extends this sharing concept from the transceiver pins to the physical traces and connectors. The routing paths from the transceiver 530 to the front-end modules utilize the same PCB traces for both FR3 and FR2-IF signals. The PCB traces connecting the transceiver 530 to the integrated FR3 cross-switch module 520 are optimized to support both the FR3 RF signals in the 7-15 GHz range and the FR2-IF signals at intermediate frequencies. The RF connectors at the interface points similarly support both signal types, eliminating the need for separate connector systems for each frequency range.

The flexible printed circuit implementation demonstrates a strategic separation of signal types to optimize cost and performance. The FR3+FR2-IF 4× signal FPC exclusively carries the high-frequency data signals, configured as four differential signal pairs that can transmit either FR3 RF or FR2-IF signals depending on the operational mode. This dedicated signal-only approach allows the FPC design to be optimized specifically for high-frequency signal transmission without the additional complexity of power distribution or control signal routing. The 4×1 configuration provides sufficient signal paths to support multiple-input multiple-output (MIMO) operation while maintaining a manageable interconnect complexity.

The routing of control signals and power for the FR2 module 512 follows a distinctly different path from the high-frequency data signals. The power supply voltage (Vbatt) required by the FR2 module 512 is routed through the main PCB using standard PCB manufacturing techniques and materials. This routing approach takes advantage of the lower frequency characteristics of power distribution, which do not require the specialized materials and controlled impedance structures necessary for high-frequency signal transmission. Similarly, the control signals that configure and manage the FR2 module 512 operation are routed on the main PCB alongside the power distribution. These control signals include digital interfaces for module configuration, enable/disable controls, and status monitoring, all of which can be effectively transmitted through standard PCB traces without the need for expensive flexible interconnect materials.

The integrated FR3 cross-switch module 520 serves as the central routing hub in this shared architecture, and its physical implementation can take multiple forms depending on the specific system requirements and manufacturing constraints. When integrated into the front-end module, the cross-switch functionality can be incorporated directly into the radio frequency front-end (RFFE) integrated circuit die. This monolithic integration provides the most compact solution and minimizes parasitic effects associated with discrete implementations. The switching elements are fabricated using the same semiconductor process as the other RFFE components, allowing for optimal performance matching and reduced signal path losses. Alternatively, the front-end module can implement the cross-switch using a dedicated PCB that houses both the RFFE IC die and discrete external cross-switch components. This hybrid approach provides flexibility in switch technology selection while maintaining a compact module form factor.

The main PCB implementation of the cross-switch offers different trade-offs in terms of system architecture and signal routing. When positioned on the smartphone's main PCB, the cross-switch can be implemented using commercially available high-frequency switch components that are mounted alongside other system components. This approach simplifies the front-end module design and allows for easier system debugging and modification. The main PCB location also provides more flexibility in terms of switch control signal routing and power distribution, as these signals can be directly connected to the system's main control processors without requiring additional interconnects.

Integration of the cross-switch functionality into the FPC represents an innovative approach that embeds the switching capability directly into the flexible interconnect structure. When implemented at the end of the FPC closest to the front-end module, the cross-switch can utilize thin-film switching elements or micro-electromechanical systems (MEMS) technology integrated into the FPC substrate. This integration minimizes the signal path length between the switch and the antenna elements, reducing insertion loss and improving overall system performance. The FPC-integrated approach also reduces the number of discrete components in the system, potentially improving reliability and reducing assembly complexity.

The RF connector implementation of the cross-switch provides another integration option that combines the switching functionality with the mechanical interconnect. When integrated into the RF connector at the end closest to the front-end module, the cross-switch can be implemented using miniaturized switching elements embedded within the connector housing. This approach maintains the modularity of the system while providing the switching functionality at the optimal location in the signal path. The connector-integrated switch can include built-in impedance matching networks and signal conditioning circuits that optimize the interface between the flexible interconnect and the front-end modules.

FIG. 6 is a flow chart 600 of a method for operating a wireless device supporting multiple frequency ranges. The method may be performed by a wireless device (e.g., the UE 250).

In operation 602, the wireless device operates in a first mode by configuring a cross-switch to establish a first signal path from a Frequency Range 3 (FR3) antenna element to a transceiver through a shared interconnect. In operation 604, the wireless device operates in a second mode by configuring the cross-switch to establish a second signal path from a Frequency Range 2 (FR2) module to the transceiver through the shared interconnect. The FR2 module outputs FR2 intermediate frequency (IF) signals. In operation 606, the wireless device transmits or receives signals through the shared interconnect in a non-concurrent manner between the first mode and the second mode.

In certain implementations, the wireless device routes power signals for the FR2 module through a main printed circuit board (PCB) separate from the shared interconnect and routes control signals for the FR2 module through the main PCB separate from the shared interconnect. The shared interconnect comprises a flexible printed circuit (FPC) configured to carry only data signals. The data signals comprise either FR3 radio frequency (RF) signals in the first mode or FR2-IF signals in the second mode. The FPC comprises four differential signal pairs configured as a 4× signal FPC.

In certain implementations, the wireless device receives the FR3 RF signals and the FR2-IF signals at a common set of pins on the transceiver and processes the FR3 RF signals and the FR2-IF signals using a common signal processing chain within the transceiver. The wireless device reuses digital front-end (DFE) and analog chains in the transceiver for processing both FR3 RF signals and FR2-IF signals. The wireless device also shares RF routing traces on a PCB between the transceiver and a front-end module for both FR3 RF signals and FR2-IF signals, and shares RF connectors on the PCB for both signal types.

In certain implementations, the wireless device down-converts an FR2 millimeter wave signal at the FR2 module to generate the FR2-IF signals before routing the FR2-IF signals to the cross-switch. The FR3 antenna element operates in a frequency range of 7-15 GHz, and the FR2 module operates in a millimeter wave frequency range above 24 GHz. The shared interconnect supports signal transmission for both frequency ranges through time-division multiplexing.

In certain implementations, the cross-switch is integrated into a radio frequency front-end (RFFE) integrated circuit die of a front-end module. In certain implementations, the cross-switch is located on a main PCB of the wireless device. In certain implementations, the cross-switch is integrated into the shared interconnect at an end closest to a front-end module. In certain implementations, the cross-switch is integrated into a radio frequency connector at an end closest to a front-end module.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operating a wireless device supporting multiple frequency ranges, comprising:
operating the wireless device in a first mode by configuring a cross-switch to establish a first signal path from a Frequency Range 3 (FR3) antenna element to a transceiver through a shared interconnect;
operating the wireless device in a second mode by configuring the cross-switch to establish a second signal path from a Frequency Range 2 (FR2) module to the transceiver through the shared interconnect, wherein the FR2 module outputs FR2 intermediate frequency (IF) signals; and
transmitting or receiving signals through the shared interconnect in a non-concurrent manner between the first mode and the second mode.

2. The method of claim 1, further comprising:
routing power signals for the FR2 module through a main printed circuit board (PCB) separate from the shared interconnect; and
routing control signals for the FR2 module through the main PCB separate from the shared interconnect.

3. The method of claim 1, wherein the shared interconnect comprises a flexible printed circuit (FPC) configured to carry only data signals, and wherein the data signals comprise either FR3 radio frequency (RF) signals in the first mode or FR2-IF signals in the second mode.

4. The method of claim 1, further comprising:
receiving the FR3 RF signals and the FR2-IF signals at a common set of pins on the transceiver; and
processing the FR3 RF signals and the FR2-IF signals using a common signal processing chain within the transceiver.

5. The method of claim 1, further comprising:
down-converting an FR2 millimeter wave signal at the FR2 module to generate the FR2-IF signals before routing the FR2-IF signals to the cross-switch.

6. The method of claim 1, wherein the cross-switch is integrated into a radio frequency front-end (RFFE) integrated circuit die of a front-end module.

7. The method of claim 1, wherein the cross-switch is located on a main PCB of the wireless device.

8. The method of claim 1, wherein the cross-switch is integrated into the shared interconnect at an end closest to a front-end module.

9. The method of claim 1, wherein the cross-switch is integrated into a radio frequency connector at an end closest to a front-end module.

10. The method of claim 1, further comprising:
reusing digital front-end (DFE) and analog chains in the transceiver for processing both FR3 RF signals and FR2-IF signals;
wherein the reusing reduces transceiver die area and pin count requirements.

11. The method of claim 3, wherein the FPC comprises four differential signal pairs configured as a 4× signal FPC.

12. The method of claim 1, further comprising:
sharing RF routing traces on a PCB between the transceiver and a front-end module for both FR3 RF signals and FR2-IF signals; and
sharing RF connectors on the PCB for both signal types.

13. The method of claim 1, wherein:
the FR3 antenna element operates in a frequency range of 7-15 GHz;
the FR2 module operates in a millimeter wave frequency range above 24 GHz; and
the shared interconnect supports signal transmission for both frequency ranges through time-division multiplexing.

14. An apparatus, the apparatus being a wireless device, comprising:
a transceiver configured to support multiple frequency ranges;
a Frequency Range 3 (FR3) antenna element;
a Frequency Range 2 (FR2) module configured to output FR2 intermediate frequency (IF) signals;
a shared interconnect coupled to the transceiver; and
a cross-switch configured to:
establish a first signal path from the FR3 antenna element to the transceiver through the shared interconnect when the wireless device operates in a first mode; and
establish a second signal path from the FR2 module to the transceiver through the shared interconnect when the wireless device operates in a second mode;
wherein the shared interconnect is configured to transmit signals in a non-concurrent manner between the first mode and the second mode.

15. The apparatus of claim 14, further comprising:
a main printed circuit board (PCB) configured to route power signals and control signals for the FR2 module separate from the shared interconnect.

16. The apparatus of claim 14, wherein the shared interconnect comprises a flexible printed circuit (FPC) configured to carry only data signals, and wherein the data signals comprise either FR3 radio frequency (RF) signals in the first mode or FR2-IF signals in the second mode.

17. The apparatus of claim 14, wherein:
the transceiver comprises a common set of pins configured to receive both the FR3 RF signals and the FR2-IF signals; and
the transceiver comprises a common signal processing chain configured to process both the FR3 RF signals and the FR2-IF signals.

18. The apparatus of claim 14, wherein the FR2 module is configured to down-convert an FR2 millimeter wave signal to generate the FR2-IF signals before routing the FR2-IF signals to the cross-switch.

19. The apparatus of claim 14, wherein the cross-switch is integrated into a radio frequency front-end (RFFE) integrated circuit die of a front-end module.

20. The apparatus of claim 14, wherein the cross-switch is located on a main PCB of the wireless device.

21. The apparatus of claim 14, wherein the cross-switch is integrated into the shared interconnect at an end closest to a front-end module.

22. The apparatus of claim 14, wherein the cross-switch is integrated into a radio frequency connector at an end closest to a front-end module.

23. The apparatus of claim 14, wherein:
the transceiver comprises digital front-end (DFE) and analog chains configured to process both FR3 RF signals and FR2-IF signals; and
the transceiver is configured with reduced die area and pin count requirements by reusing the DFE and analog chains for both signal types.

24. The apparatus of claim 16, wherein the FPC comprises four differential signal pairs configured as a 4× signal FPC.

25. The apparatus of claim 14, further comprising:
RF routing traces on a PCB between the transceiver and a front-end module, wherein the RF routing traces are shared for both FR3 RF signals and FR2-IF signals; and
RF connectors on the PCB shared for both signal types.

26. The apparatus of claim 14, wherein:
the FR3 antenna element is configured to operate in a frequency range of 7-15 GHz;
the FR2 module is configured to operate in a millimeter wave frequency range above 24 GHz; and
the shared interconnect is configured to support signal transmission for both frequency ranges through time-division multiplexing.
